(19) United States
(12) Patent Application Publication
(10) Pub. No.: US 2024/0125406 A1
(43) Pub. Date: Apr. 18, 2024

(54) VALVE DEVICE

(71) Applicant: AISAN KOGYO KABUSHIKI KAISHA, Obu-shi (JP)

(72) Inventor: Takafumi URATSUKA, Nagoya-shi (JP)

(21) Appl. No.: 18/376,141

(22) Filed: Oct. 3, 2023

(30) Foreign Application Priority Data
Oct. 14, 2022 (JP) 2022-165622

(51) Int. Cl. F16K 31/06; F16K 7/14

(52) U.S. Cl. CPC F16K 31/0672; F16K 7/14

(57) ABSTRACT

A valve device may include a housing, an inlet passage into which a fluid is introduced from outside, a first discharging unit disposed at a downstream end of the inlet passage, an outlet passage communicating with the first discharging unit and configured to discharge the fluid outside, a communication chamber communicating with the first discharging unit and including an end communicating with the outlet passage, a valve seat disposed on the first discharging unit, a valve body configured to contact the valve seat and to open and close the first discharging unit, a plunger configured to move the valve body relative to the valve seat, a driving unit fixed to the housing and supporting the plunger in a movable state, and a restricting portion configured to restrict movement of the valve body by being interposed between the plunger and the driving unit when the first discharging unit is open.

### REFERENCE TO RELATED APPLICATION

This application claims priority to Japanese Patent Application No. 2022-165622 filed on Oct. 14, 2022, the contents of which are hereby incorporated by reference into the present application.

### TECHNICAL FIELD

The description herein discloses an art related to valve devices.

### BACKGROUND ART

JP 2008-232352 A (hereinbelow termed Patent Document 1) describes a valve device configured to open and close a fluid channel. The valve device of Patent Document 1 includes a housing constituting the fluid channel, a valve seat disposed in the housing, a valve body configured to contact the valve seat, a plunger fixed to the valve body, and a driving unit fixed to the housing and supporting the plunger in a movable state. In Patent Document 1, the fluid channel is opened and closed by moving the plunger by the driving unit so that the valve body comes into contact with and separates from the valve seat. Further, in Patent Document 1, a cushioning member is disposed between the plunger and the driving unit (at a portion that is immobile relative to the housing) to suppress impact from being applied to the plunger and the driving unit by these members contacting each other. The cushioning member is disposed on the plunger an opposite side from where the plunger is fixed to the valve body.

### SUMMARY

In the case of the valve device of Patent Document 1, not only a space for the plunger to move but also a space for arranging the cushioning member need to be secured between the plunger and the driving unit. If the cushioning member is not disposed between the plunger and the driving unit, the space for arranging the cushioning member can be omitted, by which the size reduction of the valve device can be achieved accordingly. However, unless the cushioning member is disposed between the between the plunger and the driving unit, a possibility that the plunger and the driving unit come into contact cannot be eliminated, and a possibility that impact is applied to these members cannot be eliminated. That is, in Patent Document 1, the size reduction of valve components and impact suppression between the plunger and the driving unit are in a tradeoff relationship. The description herein aims to provide an art for reducing a size of a valve device while suppressing an impact between a plunger and a driving unit.

A first aspect of the art disclosed herein is a valve device configured to open and close a fluid channel. The valve device may comprise: a housing; a inlet passage disposed inside the housing and into which a fluid is introduced from outside; a first discharging unit disposed at a downstream end of the inlet passage; an outlet passage disposed inside the housing, communicating with the first discharging unit, and configured to discharge the fluid outside; a communication chamber communicating with the first discharging unit and including an end communicating with the outlet passage; a valve seat disposed on the first discharging unit; a valve body configured to contact the valve seat and to open and close the first discharging unit; a plunger fixed to the valve body and configured to move the valve body relative to the valve seat; and a driving unit fixed to the housing and supporting the plunger in a movable state. Further, the valve body may comprise a restricting portion configured to restrict movement of the valve body by being interposed between the plunger and the driving unit when the first discharging unit is open.

A second aspect disclosed herein may be the valve device of the first aspect, in which the valve body may be in a diaphragm shape and may comprise an outer peripheral portion fixed to the driving unit, a center portion fixed to the plunger, and a deformable portion disposed between the outer peripheral portion and the center portion and configured to deform when the valve body opens and closes. Further, the deformable portion may be located closer to a bottom surface of the communication chamber at its portion on a center portion side than at its portion on an outer peripheral portion side.

A third aspect disclosed herein may be the valve device of the second aspect, in which when the valve body is closed, a distance between the driving unit and the deformable portion may become larger from the outer peripheral portion toward the center portion.

According to the first aspect, the valve body functions as the cushioning member that buffers the impact application between the plunger and the driving unit. That is, according to the first aspect, the cushioning member dedicated solely to the purpose of suppressing the direct contact between the plunger and the driving unit can be omitted. The space for arranging the cushioning member does not need to be secured between the plunger and the driving unit (only the space for the plunger to move plunger needs to be secured on the opposite side from where the valve body is fixed), and the size of the valve device can be reduced. Further, by omitting the cushioning member, cost of the valve device (such as material cost and production cost) can also be reduced.

If the driving unit is of a configuration that drives the plunger by electrically conducting an electromagnetic coil (a so-called solenoid valve), it is a normally-off type, in which the valve body is normally closed when it is in a nonconductive state and opens in a conductive state. To realize the normally-off type, a spring and the like is disposed between the plunger and the driving unit and the valve body is seated on the valve seat using a biasing force (expanding force) of the spring. In this case, a space for arranging the spring and the like needs to be secured between the plunger and the driving unit. Due to this, in a conventional valve device that arranges the cushioning member between the plunger and the driving unit tends to have a smaller cushioning member size (surface area). As a result, a load (surface pressure) applied on the cushioning member when it is held between the plunger and the driving unit becomes larger, and the cushioning member becomes more susceptible to degradation. That is, durability of the cushioning member is reduced, and life of the valve device becomes shorter. According to the first aspect, by adding a function as the cushioning member to the valve body, a large cushioning member size can be secured and life of the valve device can be elongated.

According to the second aspect, the deformable portion starts to come into contact with the driving unit (starts to be held by the driving unit and the valve body) when the valve body opens (shifts from a closed state to an opened state). As a result, a wide contact area between the deformable portion and the driving unit can be secured, by which the load applied to the valve body (deformable portion) is reduced, and the life of the valve device can further be elongated. Further, since the deformable portion is disposed between the outer peripheral portion and the center portion of the valve body (that is, the deformable portion, the outer peripheral portion, and the center portion of the valve body are integrated), by starting to contact the driving unit from the outer circumferential side of the deformable portion upon when the valve opens, the center portion of the valve body (plunger fixed thereto) can be suppressed from being axially displaced. As a result, the axial displacement of the plunger is suppressed upon when the valve body closes, and a positional displacement between the valve body and the valve seat can also be suppressed. By suppressing the positional displacement between the valve body and the valve seat, sealing performance of the valve body can also be increased.

According to the third aspect, a large distance can be secured between the bottom surface of the communication chamber and the deformable portion of the valve body when the valve device is closed (when the valve body is seated on the valve seat). In other words, the deformable portion can be suppressed from approaching the bottom surface of the communication chamber. By securing the distance between the deformable portion and the bottom surface of the communication chamber, adherence of the deformable portion and the communication chamber caused by the fluid freezing under a low-temperature environment can be suppressed. Further, when deformed granules (a part of the valve body) and the communication chamber adhere to each other, the valve device can no longer function when it is to be driven (when the valve body is to be opened).

### BRIEF DESCRIPTION OF THE DRAWINGS

FIG. 1 shows a schematic view of a fuel cell system including a valve device;

FIG. 2 shows a cross-sectional view of the valve device (in a closed state);

FIG. 3 shows a cross-sectional view of the valve device (in an opened state); and

FIG. 4A and FIG. 4B shows partially enlarged views of the valve device for explaining states of a valve body when the valve device is driven.

### DETAILED DESCRIPTION

(Fuel Cell System Equipped with Valve Device)

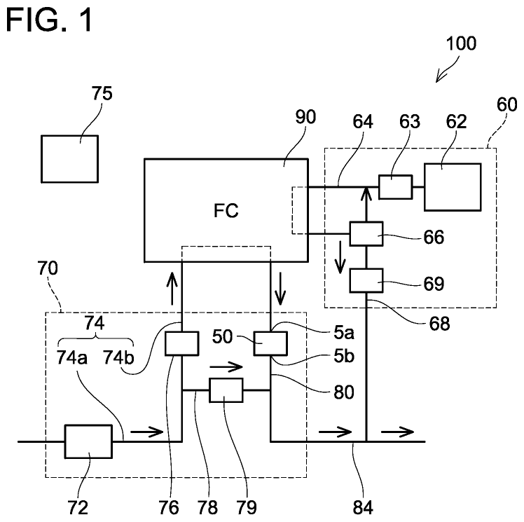

Firstly, a fuel cell system 100 that uses a valve device disclosed herein will be described with reference to FIG. 1. The fuel cell system 100 is suitably mounted on a vehicle (fuel cell vehicle). The fuel cell system 100 comprises a fuel cell stack 90, a hydrogen line 60 for supplying hydrogen gas to the fuel cell stack 90, an air line 70 for supplying air gas (external air) to the fuel cell stack 90, and a controller 75. The fuel cell system 100 is configured to generate electric power by using the hydrogen gas supplied from the hydrogen line 60 and oxygen gas (air gas) supplied from the air line 70.

The hydrogen line 60 comprises a hydrogen gas tank 62, a hydrogen supply passage 64, and a hydrogen discharging passage 68. A pressure reduction valve 63 is disposed on the hydrogen supply passage 64. A pressure of the hydrogen gas supplied from the hydrogen gas tank 62 to the hydrogen supply passage 64 is adjusted by the pressure reduction valve 63. An injector (not shown) is disposed downstream of the pressure reduction valve 63, and the hydrogen gas supplied from the hydrogen gas tank 62 is supplied to the fuel cell stack 90 by the injector. A gas-liquid separator 66 and a hydrogen-discharging valve 69 are disposed on the hydrogen discharging passage 68. The hydrogen-discharging valve 69 is an example of a valve device. The hydrogen-discharging valve 69 is disposed downstream of the gas-liquid separator 66. The hydrogen gas supply to the fuel cell stack 90 is controlled by the controller 75. That is, the controller 75 controls on/off of the hydrogen supply passage 64 and a flow rate of the hydrogen gas flowing through the hydrogen supply passage 64.

Hydrogen gas (hydrogen off gas) discharged from the fuel cell stack 90 is supplied to the gas-liquid separator 66. Hydrogen gas contained in the hydrogen off gas is extracted in the gas-liquid separator 66. The hydrogen gas extracted in the gas-liquid separator 66 is returned to the hydrogen supply passage 64 by a hydrogen circulation pump (not shown) and is supplied to the fuel cell stack 90. On the other hand, remainder of the off gas after having extracted the hydrogen gas in the gas-liquid separator 66 is discharged to the hydrogen discharging passage 68 and is discharged out of the fuel cell system 100 through a discharging pipe 84. The discharging pipe 84 is further connected to an air discharging passage 80 to be described later. A flow rate in the hydrogen discharging passage 68 is adjusted by the hydrogen-discharging valve 69. On/off of the hydrogen discharging passage 68 and a flow rate of the hydrogen off gas flowing through the hydrogen discharging passage 68 are also controlled by the controller 75. The remainder of the off gas after having extracted the hydrogen gas in the gas-liquid separator 66 contains generated water that was generated in the fuel cell system 100.

The air line 70 comprises a compressor 72, an air supply passage 74, an air discharging passage 80, a bypass passage 78, an air supply valve 76, an air-discharging valve 50, and a bypass valve 79. The compressor 72 compresses and feeds external air as the air gas into the air supply passage 74. Further, an air cleaner (not shown) is disposed upstream of the compressor 72. Due to this, clean air gas is supplied to the air supply passage 74. The air supply passage 74 connects the fuel cell stack 90 and the compressor 72. The air supply valve 76 is disposed on the air supply passage 74. Specifically, the air supply passage 74 comprises an upstream air supply passage 74a that connects the compressor 72 and the air supply valve 76 and a downstream air supply passage 74b that connects the air supply valve 76 and the fuel cell stack 90. When the compressor 72 is driven and the air supply valve 76 communicates the upstream air supply passage 74a with the downstream air supply passage 74b, the external air is supplied to the fuel cell stack 90 as the air gas. Here, an intercooler (not shown) is disposed between the compressor 72 and the air supply valve 76. The air gas of which temperature is adjusted (cooled) by the intercooler is supplied to the fuel cell stack 90.

The air discharging passage 80 is connected to the fuel cell stack 90 and discharges air off gas from the fuel cell stack 90. The discharged air off gas is discharged outside the fuel cell system 100 through the discharging pipe 84. The air-discharging valve 50 is disposed on the air discharging passage 80. The air-discharging valve 50 is a butterfly valve, and is controlled by the controller 75. An amount of the air off gas is adjusted by adjusting an opening degree of the air-discharging valve 50. The air off gas contains generated water generated in the fuel cell system 100.

The bypass passage 78 connects the air supply passage 74 and the air discharging passage 80. Specifically, one end of the bypass passage 78 is connected to the upstream air supply passage 74a and the other end thereof is connected to the air discharging passage 80 at a point downstream of the air-discharging valve 50. The bypass valve 79 is disposed on the bypass passage 78, and when the bypass valve 79 opens, the air gas in the air supply passage 74 is supplied to the air discharging passage 80.

(Hydrogen-Discharging Valve)

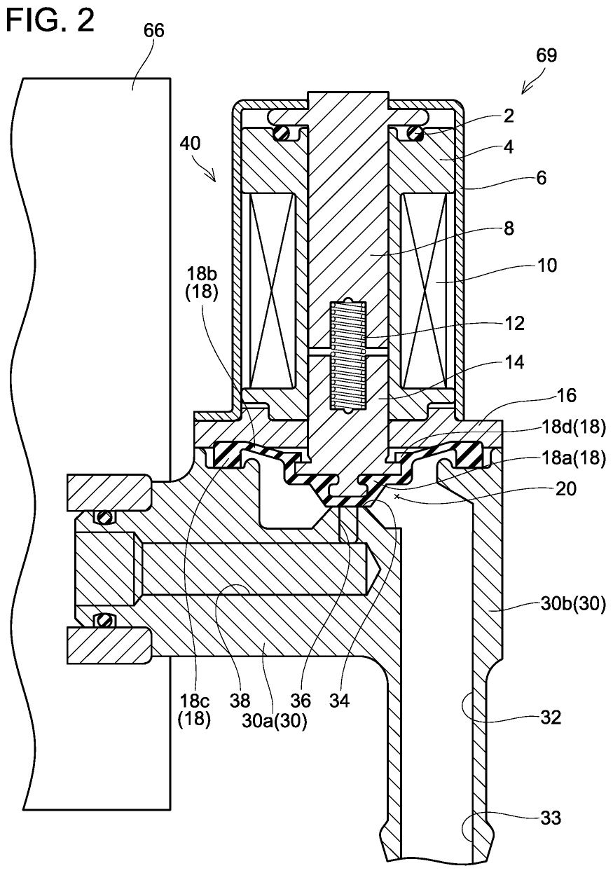

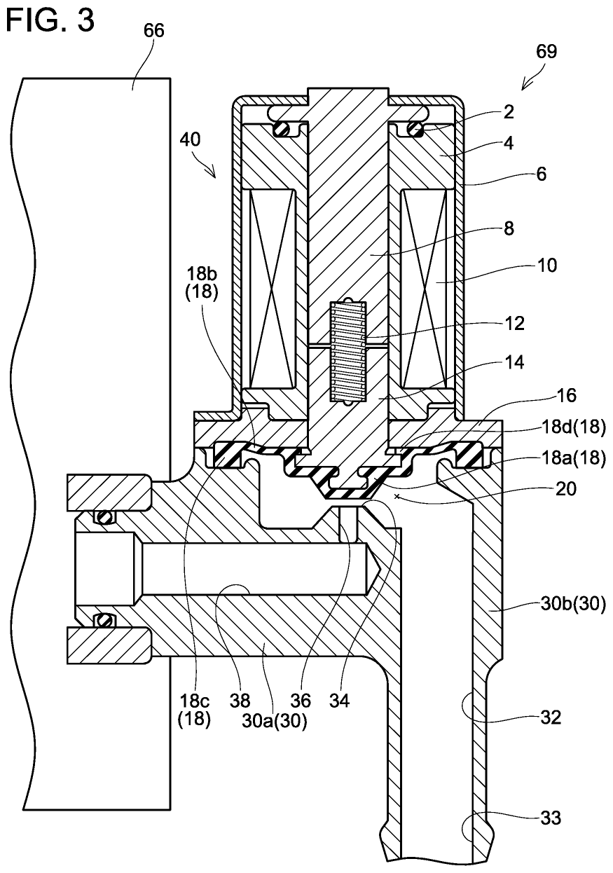

The hydrogen-discharging valve 69 will be described with reference to FIGS. 2 and 3. The hydrogen-discharging valve 69 adjusts the flow rate of the remainder of the off gas after having extracted the hydrogen gas in the gas-liquid separator 66 (generated water). As shown in FIG. 2, the hydrogen-discharging valve 69 comprises a housing 30 through which the generated water flows and a valve unit 40 configured to open and close a channel inside the housing 30. The valve unit 40 is an example of a driving unit. The housing 30 comprises a fluid introducing unit 30a in which an inlet passage 38 is defined and a fluid discharging unit 30b in which an outlet passage 32 is defined. The fluid introducing unit 30a is fixed to the gas-liquid separator 66. A coupling hose (not shown) that constitutes the hydrogen discharging passage 68 is attached to the fluid discharging unit 30b. Further, a communication chamber 20 is disposed between the inlet passage 38 and the outlet passage 32. The generated water introduced into the hydrogen-discharging valve 69 (into the housing 30) from outside the hydrogen-discharging valve 69 (gas-liquid separator 66) flows through the inlet passage 38, the communication chamber 20, and the outlet passage 32 and is discharged out of the hydrogen-discharging valve 69 (hydrogen discharging passage 68).

A first discharging unit 36 is disposed at a downstream end of the inlet passage 38. The first discharging unit 36 is disposed on a sidewall of the inlet passage 38 and opens into the communication chamber 20. The first discharging unit 36 has a shape protruding into the communication chamber 20, and its end surface constitutes a valve seat 34 on which a valve body 18 is to be seated (these elements will be explained later). The first discharging unit 36 has a smaller channel area than the inlet passage 38 and has an orifice shape. A direction along which the first discharging unit 36 extends and a direction along which the inlet passage 38 extends are different. The first discharging unit 36 extends in a direction that substantially intersects orthogonally the direction along which the inlet passage 38 extends. Specifically, the first discharging unit 36 extends in a substantially vertical direction and the inlet passage 38 extends in a substantially horizontal direction. Due to this, the generated water introduced into the inlet passage 38 flows in the inlet passage 38 in the horizontal direction, flows upward inside the first discharging unit 36, and is thereafter discharged into the communication chamber 20.

An upstream end of the outlet passage 32 communicates with the communication chamber 20. Due to this, the outlet passage 32 communicates with the inlet passage 38 via the communication chamber 20 and the first discharging unit 36. The generated water guided into the outlet passage 32 from the communication chamber 20 flows downward inside the outlet passage 32, and is discharged outside the hydrogen-discharging valve 69 (hydrogen discharging passage 68) from a second discharging unit 33 disposed at a downstream end of the outlet passage 32.

The valve unit 40 is fixed above the housing 30. The valve unit 40 comprises a cylindrical fixation base 4, an electromagnetic coil 10 disposed on an outer circumference of the fixation base 4, an attraction member 8 disposed inside the fixation base 4, a plunger 14 disposed coaxially with the attraction member 8 inside the fixation base 4, a mount plate 16 fixed to the fixation base 4, a valve body 18 fixed to the plunger 14 and the mount plate 16, and a cover 6.

The electromagnetic coil 10 is disposed in a recess defined in an outer circumferential surface of the fixation base 4. A size of an upper end of the attraction member 8 is greater than a cross-sectional size (inner diameter) of the cylindrical fixation base 4. The upper end of the attraction member 8 contacts an upper end surface of the fixation base 4 and separates inside of the cylindrical fixation base 4 from outside. An O-ring 2 is disposed between the upper end of the attraction member 8 and an upper end surface of the fixation base 4, and this O-ring 2 seals the cylindrical fixation base 4. The attraction member 8 is a magnetic body, and a part thereof faces a part of the electromagnetic coil 10.

A coil spring 12 is disposed between the attraction member 8 and the plunger 14. The coil spring 12 is fixed to both the attraction member 8 and the plunger 14 and thereby suppresses these members from coming into contact with each other. The plunger 14 extends through a through hole defined at a center of the mount plate 16. A distal end of the plunger 14 (opposite end from the attraction member 8) has the valve body 18 fixed thereon. A size of the plunger 14 on a distal end side (its portion housed inside the communication chamber 20) is greater than a size of the through hole of the mount plate 16.

The valve body 18 is constituted of rubber and is in a diaphragm shape. A center portion 18a of the valve body 18 is fitted in the distal end of the plunger 14, and the valve body 18 and the plunger 14 are thereby fixed to each other. An outer peripheral portion 18c of the valve body 18 is fixed to the mount plate 16. That is, the outer peripheral portion 18c of the valve body 18 is fixed to the valve unit 40 being the driving unit. Specifically, the outer peripheral portion 18c of the valve body 18 is fixed to the valve unit 40 by having the outer peripheral portion 18c held by a surface of the mount plate 16 on a housing 30 side and a surface of the housing 30 on a mount plate 16 side. A deformable portion 18b configured deformable compliant to an operation of the plunger 14 is disposed between the center portion 18a and the outer peripheral portion 18c. A restricting portion 18d that covers a distal end portion of the plunger 14 (portion thereof with the size larger than that of the through hole of the mount plate 16) is disposed inside the deformable portion 18b (on a center portion 18a side). Specifically, the restricting portion 18d covers an upper portion (mount plate 16 side) of the distal end portion of the plunger 14 and is interposed between the distal end portion of the plunger 14 and the mount plate 16. Here, a thickness of the deformable portion 18b is constant except for the restricting portion 18d.

The mount plate 16 is fixed to an upper surface of the housing 30. When the mount plate 16 is fixed to the housing 30, the valve body 18 comes to face the valve seat 34. More specifically, the center portion 18a of the valve body 18 is pressed onto the valve seat 34 (is seated thereon) by a biasing force (expanding force) of the coil spring 12, by which the first discharging unit 36 is closed. While the valve body 18 (center portion 18a) is seated on the valve seat 34, the inlet passage 38 and the outlet passage 32 do not communicate with each other, thus the generated water is not discharged from the hydrogen-discharging valve 69. Further, the cover 6 is fixed to an upper surface of the mount plate 16 and covers the fixation base 4 and the electromagnetic coil 10, and further isolates the fixation base 4 and the electromagnetic coil 10 from outside.

As shown in FIG. 3, when the electromagnetic coil 10 is electrically conducted, the attraction member 8 is magnetically excited and the plunger 14 is thereby attracted to the attraction member 8. That is, the plunger 14 is attracted toward the attraction member 8 by a magnetic excitation force of the attraction member 8 and moves upward by compressing the coil spring 12. The valve unit 40 is of a normally-off type. When the plunger 14 moves upward, the center portion 18a of the valve body 18 moves upward together with the plunger 14, and the valve body 18 separates from the valve seat 34. When the valve body 18 separates from the valve seat 34, the inlet passage 38 communicates with the outlet passage 32 and the generated water is discharged from the hydrogen-discharging valve 69.

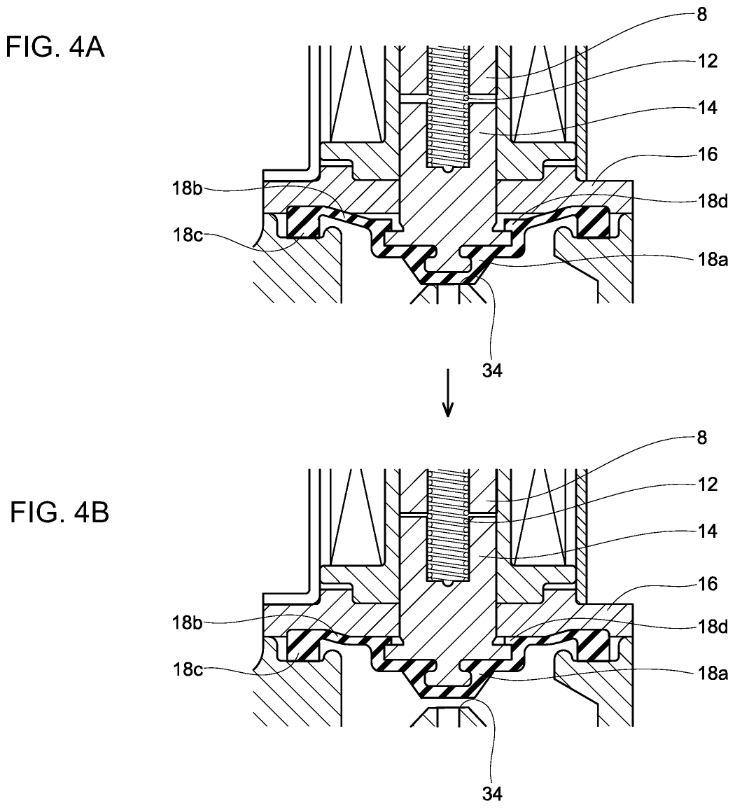

Next, states of the valve body 18 when the hydrogen-discharging valve 69 is actuated will be described with reference to FIG. 4A and FIG. 4B. FIG. 4A shows a closed state (in a nonconductive state) and FIG. 4B shows an opened state (in a conductive state). Firstly, the state of the valve body 18 in the closed state (a) will be described. As described above, the valve body 18 has its center portion 18a fixed to the plunger 14 and its outer peripheral portion 18c fixed to the mount plate 16 (held between the mount plate 16 and the housing 30). The deformable portion 18b extends substantially linearly (by being flat) from the outer peripheral portion 18c toward the center portion 18a, and the deformable portion 18b is thus not warped. In other words, when the valve body 18 is closed, the deformable portion 18b is located closer to a bottom surface of the communication chamber 20 from the outer peripheral portion 18c toward the center portion 18a. As a result, a distance between the deformable portion 18b and the bottom surface of the communication chamber 20 can be secured in the closed state.

As described above, the generated water introduced into the housing 30 flows through the inlet passage 38, the communication chamber 20, and the outlet passage 32. Due to this, even in the closed state, the generated water may still remain inside the communication chamber 20. The generated water still remaining inside the communication chamber 20 in the closed state may freeze under a low-temperature environment. If the distance between the deformable portion 18b and the bottom surface of the communication chamber 20 is secured when the generated water freezes, the deformable portion 18b and the communication chamber 20 can be suppressed from adhering to each other. By suppressing adherence of the deformable portion 18b and the communication chamber 20, the valve body 18 can be ensured to open upon shifting to the opened state (conductive state). Further, by suppressing the adherence between the deformable portion 18b and the communication chamber 20, deterioration of the deformable portion 18b can also be suppressed.

Further, in the closed state, a distance between the mount plate 16 and the deformable portion 18b (space between a surface of the mount plate 16 on a deformable portion 18b side and a surface of the deformable portion 18b on a mount plate 16 side) becomes gradually larger from an outer peripheral portion 18c side toward a center portion 18a side. Due to this, in shifting from the closed state (a) to the opened state (b), the deformable portion 18b starts to make contact with the mount plate 16 from the outer peripheral portion 18c side. As a result, almost the entire surface of the deformable portion 18b comes into contact with the mount plate 16 (entirety of the deformable portion 18b from the outer peripheral portion 18c side toward the center portion 18a side comes into contact with the mount plate 16), and a wide contact area can be secured between the deformable portion 18b and the mount plate 16. For example, when the deformable portion is to make contact with the mount plate from the center portion side upon shifting to the opened state, a middle portion of the deformable portion (on the center portion side and the outer peripheral portion side) may not come into contact with the mount plate due to the center portion side and the outer peripheral portion side of the deformable portion being restrained by the outer peripheral portion of the valve body being fixed. As a result, a load applied to the deformable portion increases and durability of the deformable portion (valve body) is thereby decreased. Upon shifting from the closed state (a) to the opened state (b), the load applied to the deformable portion can be reduced and the durability of the deformable portion (valve body) can be improved by configuring the deformable portion 18b to start coming into contact with the mount plate 16 from the outer peripheral portion 18c side.

Further, by configuring the deformable portion 18b to start coming into contact with the mount plate 16 from the outer peripheral portion 18c side upon shifting from the closed state (a) to the opened state (b), an axial displacement of the plunger 14 upon shifting to the opened state is suppressed, as a result of which an axial displacement of the plunger 14 upon shifting to the opened state is also suppressed. By suppressing the axial displacement of the plunger 14, the center portion 18a of the valve body 18 comes into sufficient contact with the valve seat 34 upon shifting to the closed state, and the sealing performance of the valve body 18 is also improved.

As shown in the opened state (b), the restricting portion 18d is held by the mount plate 16 and the plunger 14 in the opened state. As a result, movement of the plunger 14 (upward movement toward the attraction member 8) is restricted, and the upward movement of the plunger 14 is stopped. In a state where the upward movement of the plunger 14 is stopped (opened state (b)), a small space exists between the plunger 14 and the attraction member 8. That is, in the hydrogen-discharging valve 69, the plunger 14 and the attraction member 8 do not come into direct contact or into indirect contact via a cushioning member in the opened state. In the hydrogen-discharging valve 69, an impact application between the plunger 14 and the attraction member 8 in the opened state can be suppressed without arranging a cushioning member between the plunger 14 and the attraction member 8. The hydrogen-discharging valve 69 does not need to secure a space for arranging the cushioning member between the plunger 14 and the attraction member 8, and device size reduction is thereby achieved.

As described above, in the hydrogen-discharging valve 69, a small space exists between the plunger 14 and the attraction member 8 in the opened state (b). The impact application between the plunger 14 and the attraction member 8 can be suppressed by arranging the cushioning member in this space. However, in this case, when the device size reduction is to be realized (when the space between the plunger 14 and the attraction member 8 is made smaller), a thickness of the cushioning member becomes thinner, and the impact between the plunger 14 and the attraction member 8 cannot suitably be reduced. Further, when the thickness of the cushioning member is made thinner, life of the cushioning member also decreases. The hydrogen-discharging valve 69 can therefore be evaluated as being compact with high durability.

Further, as described above, the coil spring 12 is disposed between the plunger 14 and the attraction member 8. Due to this, if the cushioning member is to be disposed between the plunger 14 and the attraction member 8, the cushioning member needs to be disposed where the coil spring 12 is not disposed. As a result, a surface area of the cushioning member becomes small, and the impact between the plunger 14 and the attraction member 8 cannot sufficiently be reduced (or the durability of the disposed cushioning member decreases). A large area for arranging the cushioning member can be secured by designing the size of the coil spring 12 to be small, and the surface area of the cushioning member can thereby be increased. However, in this case, the biasing force of the coil spring 12 decreases, and the sealing performance of the valve body 18 decreases in the opened state (b).

The hydrogen-discharging valve 69 can achieve advantages such as device size reduction, improvement in device durability, and improvement in the sealing performance of the valve body 18 decreases in the opened state (b) by suppressing contact between the plunger 14 and the attraction member 8 using the restricting portion 18d disposed on the valve body 18 without arranging a cushioning member between the plunger 14 and the attraction member 8.

### OTHER EMBODIMENTS

In the above embodiment, the fuel cell system 100 provided with the hydrogen-discharging valve 69 and the air-discharging valve 50 has been described. The structure of the hydrogen-discharging valve 69 may be applied to the air-discharging valve 50. That is, a valve device identical to that of the hydrogen-discharging valve 69 may be used as the air-discharging valve 50.

In the above embodiment, a configuration was described in which the thickness of the deformable portion is constant except for the restricting portion. That is, in the hydrogen-discharging valve (valve device) of the embodiment, the thickness of the restricting portion is different from the thickness of the deformable portion not including the restricting portion. However, the thickness of the restricting portion may be same as the thickness of the deformable portion not including the restricting portion. The thickness of the restricting portion can freely be selected in accordance with the force applied to the restricting portion in the opened state.

In the above embodiment, a configuration was described in which, in the closed state, the deformable portion gradually approaches closer to the bottom surface of the communication chamber from an outer peripheral portion side toward a center portion side of the valve body. However, this configuration is merely one of preferred embodiments, and for example, a portion closer to the bottom surface of the communication chamber than a centermost portion may exist in a middle portion of the deformable portion (between an outermost peripheral portion and the centermost portion thereof). So long as the deformable portion and the communication chamber are not in contact at least in the closed state, the deformable portion and the communication chamber can be suppressed from adhering to each other when the generated water freezes.

Further, in the above embodiment, a configuration was described in which, in the closed state, the distance between the mount plate and the deformable portion becomes larger from the outer peripheral portion side toward the center portion side of the valve body. Further, it also has been explained that a wide contact area can thereby be secured between the deformable portion and the mount plate (portion not contacting the mount plate does not exist in the middle portion of the deformable portion). However, this is also merely one of preferred embodiments. For example, a groove and the like may be defined in the deformable portion to allow the thickness of the deformable portion to change, and the entire deformable portion can be brought into contact with the mount plate even if the deformable portion comes into contact with the mount plate from the center portion side upon shifting to the opened state due to the thickness of the deformable portion changing (a length of the deformable portion in a planar direction changing).

Specific examples of the invention disclosed herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A valve device configured to open and close a fluid channel, the valve device comprising:
a housing;
an inlet passage disposed inside the housing and into which a fluid is introduced from outside;
a first discharging unit disposed at a downstream end of the inlet passage;
an outlet passage disposed inside the housing, communicating with the first discharging unit, and configured to discharge the fluid outside;
a communication chamber communicating with the first discharging unit and including an end communicating with the outlet passage;
a valve seat disposed on the first discharging unit;
a valve body configured to contact the valve seat and to open and close the first discharging unit;
a plunger fixed to the valve body and configured to move the valve body relative to the valve seat; and
a driving unit fixed to the housing and supporting the plunger in a movable state,
wherein the valve body comprises a restricting portion configured to restrict movement of the valve body by being interposed between the plunger and the driving unit when the first discharging unit is open.

2. The valve device according to claim 1, wherein
the valve body is in a diaphragm shape and comprises an outer peripheral portion fixed to the driving unit, a center portion fixed to the plunger, and a deformable portion disposed between the outer peripheral portion and the center portion and configured to deform when the valve body opens and closes, and
the deformable portion is located closer to a bottom surface of the communication chamber at its portion on a center portion side than at its portion on an outer peripheral portion side.

3. The valve device according to claim 2, wherein when the valve body is closed, a distance between the driving unit and the deformable portion becomes larger from the outer peripheral portion toward the center portion.
